(19) United States
(12) Patent Application Publication
(10) Pub. No.: US 2018/0213078 A1
(43) Pub. Date: Jul. 26, 2018

(54) APPLICATION MANAGEMENT FOR A MOBILE DEVICE

(71) Applicant: BandwidthX Inc., Carlsbad, CA (US)

(72) Inventors: Pertti VISURI, Fallbrook, CA (US); Marcel MAHDAVI, Seattle, WA (US); Chris VAN HAMERSVELD, San Marcos, CA (US); Jay DILLS, Poway, CA (US); Carlos RIVERA, Ramona, CA (US)

(21) Appl. No.: 15/874,169

(22) Filed: Jan. 18, 2018

Related U.S. Application Data
(60) Provisional application No. 62/449,277, filed on Jan. 23, 2017.

(51) Int. Cl. H04M 1/725; H04W 4/14; H04W 8/22

(52) U.S. Cl. CPC H04M 1/72552; H04W 4/14; H04M 15/844; H04W 8/22; H04M 1/72561; H04M 1/72525

(57) ABSTRACT

Application management for a mobile device. In an embodiment, identifier(s) of a mobile device are received over a network. A determination is made as to whether the mobile device has installed a software application based on the identifier(s). When the mobile device is not determined to have installed the software application, a Short Message Service (SMS) message is initiated for providing access to the software application to the mobile device. The access to the software application is provided to the mobile device via the SMS message. After the software application is provided to the mobile device, a determination is made as to whether the mobile device has installed the software application, and, when the mobile device is not determined to have installed the software application, reminder(s) are initiated to the mobile device. Each reminder may comprise an SMS message.

### CROSS-REFERENCE TO RELATED APPLICATIONS

This application claims priority to U.S. Provisional Patent App. No. 62/449,277, filed on Jan. 23, 2017—the entirety of which is hereby incorporated herein by reference.

### BACKGROUND

### Field of the Invention

The embodiments described herein are generally directed to application management for a mobile device, and, more particularly, to downloading, installing, and/or updating a client software application on a mobile device.

### Description of the Related Art

A mobile application or “app” is a software application developed by a device manufacturer, mobile network operator (MNO), service provider, or third party to be executed on a mobile device, such as a smartphone or laptop. Mobile applications are developed for a variety of reasons, such as to provide core operating system functionality, improved productivity, information retrieval, curation sources, quality of service (QoS) and/or quality of experience (QoE), and/or a reduction in cellular data usage for cost savings.

There are three basic types of software applications available for mobile devices: core applications; pre-installed third-party applications; and user-installed applications. Core applications are installed as part of the base operating system, and are generally non-removable and updated during full-system updates. Pre-installed third-party applications are installed by the MNO, service provider, device manufacturer, or other third party, and are not part of the core operating system. User-installed applications are usually third-party applications that are installed by the user of the mobile device.

Most mobile devices are available with several pre-installed software applications, such as a web browser app, email client app, virtual calendar app, media app, weather app, and/or stock app. Software applications that are not pre-installed are usually available via distribution platforms, such as the Apple™ App Store, Google Play™, or another third-party platform. However, with the increasing trend towards ensuring that mobile device users are in control of how their devices function and which applications to use, pre-installed applications have become less desirable for mobile device users. The bring-your-own-device (BYOD) movement is an example of this trend. Such a trend represents a growing challenge to the management of installations and updates of software applications for the improvement of user experience.

One example of how third-party applications benefit end users is the bandwidth exchange (BX) market, provided by BandwidthX, Inc. of Carlsbad, Calif. Specifically, BandwidthX provides a software application, which mobile device users can download and install, that performs radio management to reduce cellular data usage, avoid overage data charges (e.g., by using a Wi-Fi™ connection when possible), take advantage of lower data usage prices (e.g., per gigabyte of data used) offered by an alternative network, and/or improve QoS and/or QoE.

Thus, what is needed is application management for mobile devices that provides users with both the control that pre-installation does not and the benefits of third-party applications that would normally be pre-installed.

### SUMMARY

Accordingly, embodiments of application management for a mobile device are disclosed.

In an embodiment, a method is disclosed. The method comprises using at least one hardware processor of a server to: receive at least one identifier of a mobile device over at least one network; determine whether the mobile device has installed a software application based on the at least one identifier of the mobile device; when the mobile device is not determined to have installed the software application, initiate a first Short Message Service (SMS) message for providing access to the software application to the mobile device; provide access to the software application to the mobile device via the first SMS message over at least one network; and, after providing access to the software application to the mobile device, determine whether the mobile device has installed the software application, and, when the mobile device is not determined to have installed the software application, initiate at least one reminder to the mobile device, wherein the at least one reminder comprises a second SMS message. The method may be embodied in executable software modules of a processor-based system, such as a mobile device, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIGS. 1A and 1B illustrate example infrastructures, in which one or more of the processes described herein, may be implemented, according to embodiments;

FIG. 2 illustrates an example processing system, by which one or more of the processed described herein, may be executed, according to an embodiment; and

FIG. 3 illustrates a process for application management (e.g., operational download and/or management of installations and/or upgrades) for a mobile device, according to an embodiment.

### DETAILED DESCRIPTION

In an embodiment, systems, methods, and non-transitory computer-readable media are disclosed for application management for a mobile device. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

This description may relate and refer to subject matter discussed in U.S. Pat. No. 9,084,179, issued on Jul. 14, 2015, U.S. Pat. No. 9,288,831, issued on Mar. 15, 2016, U.S. Pat. No. 9,345,059, issued on May 17, 2016, U.S. Pat. No. 9,549,082, issued on Jan. 17, 2017, U.S. Pat. No. 9,781,277, issued on Oct. 3, 2017, U.S. Patent Pub. No. 2014/0293829, published on Oct. 2, 2014, U.S. Patent Pub. No. 2015/0189580, published on Jul. 2, 2015, U.S. Patent Pub. No. 2017/0094515, published on Mar. 30, 2017, International Patent Pub. No. WO/2016/109742, published on Jul. 7, 2016, International Patent Pub. No. WO/2016/109745, published on Jul. 7, 2016, U.S. patent application Ser. No. 15/848,534, filed on Dec. 20, 2017, U.S. patent application Ser. No. 15/847,496, filed on Dec. 19, 2017, U.S. patent application Ser. No. 15/848,603, filed on Dec. 20, 2017, U.S. patent application Ser. No. 15/848,651, filed on Dec. 20, 2017, and U.S. patent application Ser. No. 15/845,410, filed on Dec. 18, 2017—the entireties of all of which are hereby incorporated herein by reference.

1. System Overview

1.1. Infrastructure

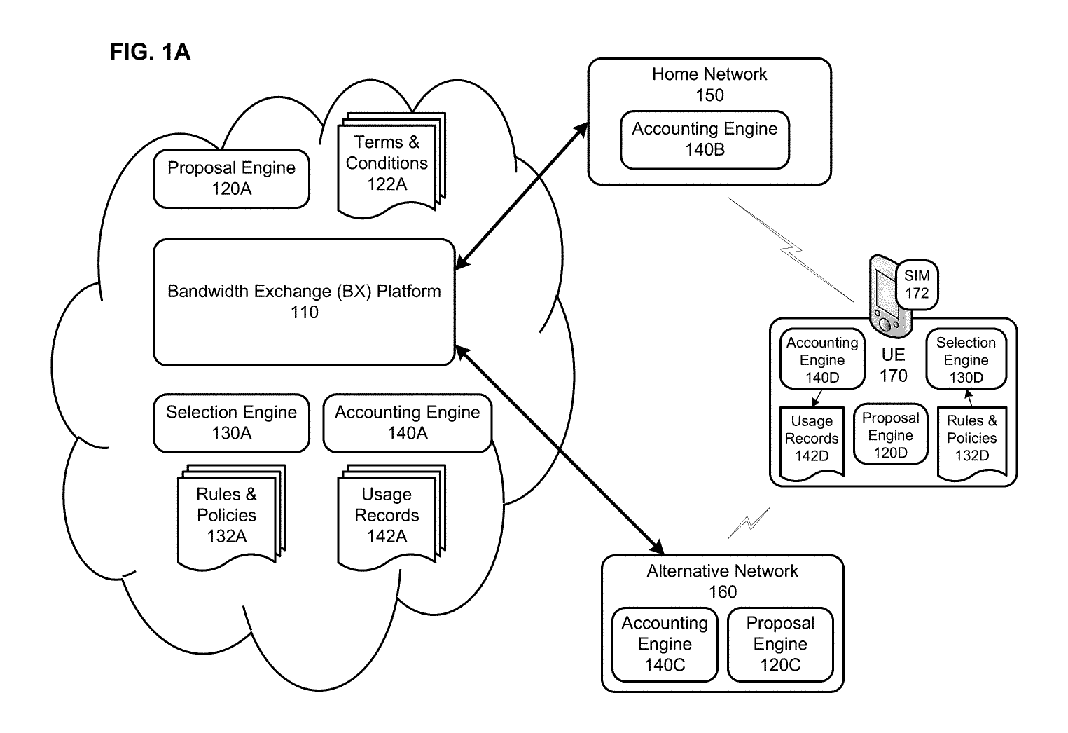

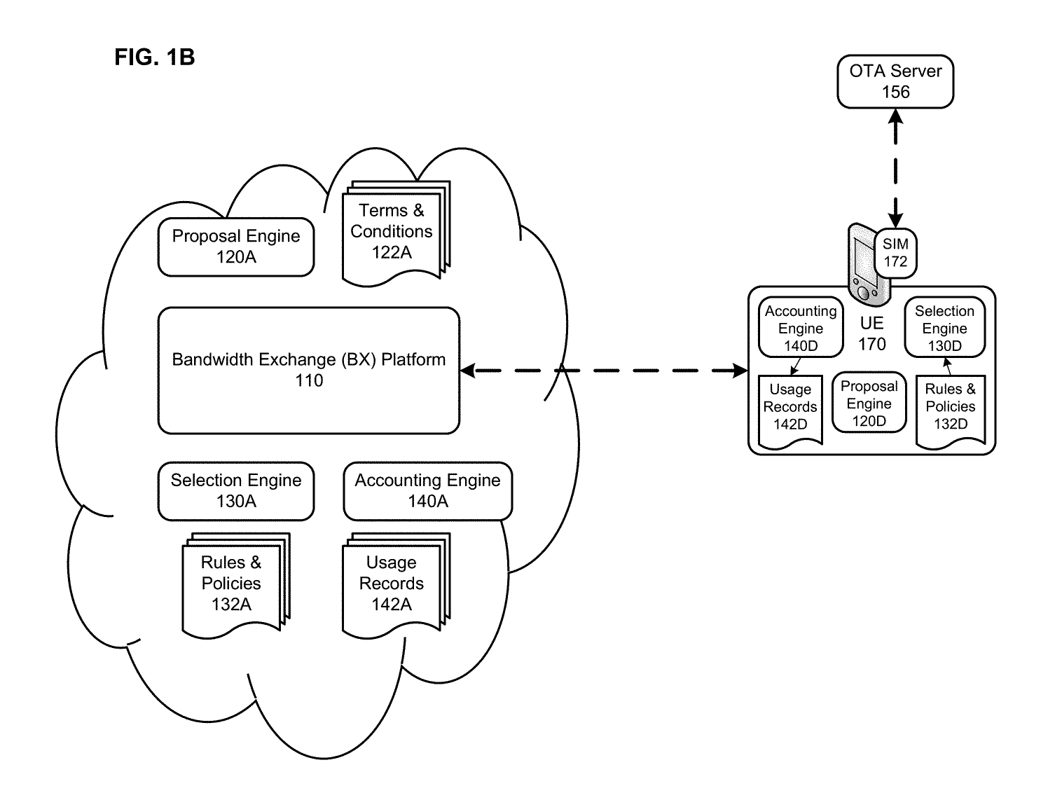

FIG. 1A illustrates an example system for bandwidth exchange, according to an embodiment. Embodiments of the system enable service providers for wireless devices (e.g., mobile devices) and network service providers of home or alternative networks to manage network selection for the devices and conduct micro-commerce on bandwidth or data connectivity, based on one or more parameters pertaining to the characteristics of the available connections to alternative wireless networks and the current situation of the network and device operations.

The bandwidth exchange may be implemented as a bandwidth exchange (BX) platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed.

Platform 110 may be communicatively connected via one or more networks (e.g., the Internet) to a home network 150 (e.g., a cellular network) and one or more alternative networks 160 (e.g., a cellular or Wi-Fi™ network)—either of which may provide communication between platform 110 and one or more wireless devices 170 (also referred to herein as “user equipment” (UE) or mobile devices). Home network 150 may comprise a cellular network, and alternative network 160 may comprise a cellular network or a non-cellular network (e.g., a Wi-Fi™ network). A cellular network may utilize 2G (e.g., GSM, GPRS, EDGE, iDEN, TDMA, CDMA), 3G (e.g., CDMA2000, 1×-EVDO, WCDMA, UMTS, HSPA), 4G (e.g., LTE, LTE-A), 5G etc., whereas a non-cellular network may utilize, for example, one or more of the family of 802.11 standards from The Institute of Electrical and Electronic Engineers (IEEE), or other non-cellular network standards. Home network 150 may be operated by a mobile network operator (MNO), a mobile virtual network operator (MVNO), or a wireless service provider. Alternative network 160 may be operated by a MNO, a MVNO, or a wireless service provider, or may be a free Wi-Fi™ service (e.g., a home Wi-Fi™ network, a Wi-Fi™ service provided by a city library, a business, etc.), or a paid Wi-Fi™ service (e.g., offered by an Internet service provider). While only one home network 150, one alternative network 160, and one UE 170 are illustrated, it should be understood that platform 110 may communicate with any number of home networks, alternative networks, access points, and UEs. In addition, UEs 170 may comprise any type or types of computing devices capable of wireless communication, including without limitation, laptop computers, tablet computers, smart phones or other mobile phones, servers, game consoles, televisions, set-top boxes, electronic kiosks, point-of-sale terminals, Automated Teller Machines, and the like.

Each UE 170 (also referred to herein as a “wireless device” or “mobile device”) may comprise a first radio system, a second radio system, a client software application (e.g., a BX application), and a local database. Each UE 170 may be configured to turn on or off one or both of the first and second radio systems independently of each other. The first radio system uses a first wireless communication protocol (e.g., a protocol used for a cellular network) to wirelessly connect to an access point (e.g., a cellular base station providing or otherwise serving one or more sectors of a cellular network), which provides access to home network 150 or alternative network 160. The second radio system uses a second wireless communication protocol (e.g., Wi-Fi™) to wirelessly connect to an access point (e.g., a Wi-Fi™ access point), which provides access to alternative network 160. It should be understood that the first wireless communication protocol may be different from the second wireless communication protocol.

Platform 110 may comprise web servers which host one or more websites and/or web services. In embodiments in which a website is provided, the website may comprise one or more user interfaces, including, for example, webpages generated in HyperText Markup Language (HTML) or other language. Platform 110 transmits or serves these user interfaces in response to requests from user systems (e.g., of MNOs). In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to platform 110 and the responses from platform 110, including the user interfaces, may both be communicated through one or more networks, which may include the Internet, using standard communication protocols (e.g., Hypertext Transfer Protocol (HTTP), HTTP Secure (HTTPS), etc.). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases that are locally and/or remotely accessible to platform 110.

In embodiments in which a web service is provided, platform 110 may receive requests from one or more external systems, and provide responses in eXtensible Markup Language (XML) and/or any other suitable or desired format. In such embodiments, platform 110 may provide an application programming interface (API) which defines the manner in which the external systems (e.g., an application executed on a UE 170, server, or other device) may interact with the web service. Thus, the external systems, can define their own user interfaces, and rely on the web service to implement or otherwise provide the backend processes, methods, functionality, storage, etc., described herein. For example, in such an embodiment, a client application (e.g., BX application comprising proposal engine 120D, selection engine 130D, and/or accounting engine 140D) executing on one or more UEs 170 may interact with a server application executing on platform 110 to execute one or more or a portion of one or more of the various functions, processes, methods, and/or software modules described herein. The client application may be “thin,” in which case processing is primarily carried out server-side by the server application on platform 110. Alternatively, the client application may be “thick,” in which case processing is primarily carried out client-side by the external system. It should be understood that the client application may perform an amount of processing, relative to the server application on platform 110, at any point along this spectrum between “thin” and “thick,” depending on the design goals of the particular implementation. In any case, the application described herein, which may wholly reside on either platform 110 or UEs 170, or be distributed between platform 110 and UEs 170, can comprise one or more executable software modules that implement one or more of the processes, methods, or functions of the application(s) described herein.

The BX market can be formed by agreements with wireless operators/service providers and/or individual wireless device users, as well as with a number of individuals or companies that own or control alternative radio access resources. The BX market may be implemented by combinations of a proposal engine 120, a selection engine 130, and an accounting engine 140. Proposal engine 120 and accounting engine 140 may reside in (e.g., be executed as software modules by a processor of) platform 110, home network 150, alternative network 160 (e.g., a processor of an access point of alternative network 160), and/or UE 170. Selection engine 130 may reside on platform 110 and/or UE 170.

FIG. 1B illustrates an example system for providing application management, according to an embodiment. As illustrated, BX platform 110 communicates with a software application (e.g., BX application) executing on UE 170 (e.g., via home network 150 and/or alternative network 160), and an over-the-air (OTA) server 156 communicates with a Subscriber Identity Module (SIM) 172 (e.g., via home network 150 and/or alternative network 160) on UE 170. SIM 172 may be a SIM card, a Universal SIM (USIM) card, or an electronic SIM (eSIM). OTA server 156 may be comprised in home network 150, alternative network 160, and/or BX platform 110.

In an embodiment, OTA server 156 is a computer server (or cloud instance) that updates and changes data in smart cards (e.g., SIM 172) without having to reissue the smart cards. OTA server 156 provides the ability to introduce new services or to modify the content of smart cards in an efficient and rapid manner. OTA server 156 may have an interface to an operator's back-end system, including business support systems, customer care systems, billing and provisioning systems, etc. In addition, OTA server 156 may have an interface to a short message service (SMS) center (SMSC) server for exchanging short messages. OTA server 156 can uniquely identify a SIM card by the Integrated Circuit Card Identifier (ICCID). OTA server 156 may be controlled by an MNO, a wireless service provider (e.g., MVNO), or a third party.

1.1.1 Proposal Engine

In an embodiment, proposal engine 120 provides access or a reference to the terms and conditions 122 for using a particular connection or connections. In particular, each proposal engine 120 is associated with an alternative network 160 and provides selection engine 130 with information about the connection to the alternative network 160. This information may include the terms and conditions 122, as well as detailed information about the characteristics of the connection to the alternative network 160. For example, the information provided by proposal engine 120, as terms and conditions 122, may include one or more of the following parameters:
(1) Price(s) of using the connection, which may vary according to the time of day or the day of month or year, and which may change dynamically in response to the current demand from other selection engines 130.
(2) Level of security available for using the connection.
(3) Historical data about bandwidth, data rate, throughput, packet loss, stability, jitter, and/or other performance characteristics of the connection. Selection engine 130 may use this data, but may have UE 170 conduct its own tests to determine the bandwidth and/or other performance characteristics of the connection (e.g., jitter, packet delays of retransmissions during the connection, etc.), and makes its own determination about the quality of the connection.
(4) Sponsorship for or promotions related to the connection (e.g., websites or specific promotions available or required through the connection). For example, some connections may be sponsored by advertisers. In that case, the nature of the products being advertised and/or the frequency and obtrusiveness of the advertisements may be communicated by proposal engine 120 to selection engine 130, such that selection engine 130 may consider the connection based on this information. Some end users may be interested in advertisements on certain topics (e.g., topics close to the end users' hearts), but may wish to avoid connections which will require advertisements on other topics or certain undesired topics.
(5) Quality of the connection (e.g., Internet connection provided through the connection); and/or
(6) Special instructions from the operator of home network 150 and/or the end user of UE 170.

The set of parameters used in the selection process will depend on the complexity of the given proposal engine 120 and selection engine 130. For example, a less sophisticated selection engine 130 may only be capable of selecting a connection based on signal strength and price. However, a more sophisticated selection engine 130 may be capable of considering more information and alternatives in the terms and conditions 122, provided by a proposal engine 120, to thereby increase its capabilities.

Other information, pertaining to terms and conditions 122 of using an access point, may be relevant. For example, some access points may belong to a network of hotspots controlled by a wireless operator or wireless Internet Service Provider (ISP) that offers fixed-fee or other special pricing to subscribers of their services. If the end user of UE 170 is a subscriber to such a hotspot network, terms and conditions 122 would normally be stored in proposal engine 120D, and the hotspot access point would provide information identifying that it belongs to the hotspot network (for example in its SSID). Alternatively or additionally, proposal engine 120 (e.g., proposal engine 120C) for the access point may provide the indication that the access point belongs to the hotspot network.

There may be special information transmitted by the UE's home network 150. For example, from the home-network operator's point of view, the desirability to offload a UE 170 to alternative network 160 may depend on the load within the sector (e.g., on the cellular tower) of home network 150 to which UE 170 is connected. To manage the connections in an optimal way, BX platform 110 may instruct selection engine 130 for a UE 170 in a particular sector of home network 150 and/or at a particular time to seek the lowest price alternative even when a connection to home network 150 is available (e.g., if the load on that sector is above a threshold).

Proposal engine 120 may be implemented as a module on an access point of alternative network 160 (e.g., proposal engine 120C), elsewhere within alternative network 160, and/or on BX platform 110. A proposal engine 120, associated with an access point, provides information about that access point (e.g., the availability, connectivity services provided, and/or other information) to UEs 170 (e.g., to selection engine(s) 130 associated with each UE 170). This information may include the terms and conditions, including the price, of using connectivity through the access point, and may include detailed information about the characteristics of the connection to alternative network 160 provided by the access point. Implementations of proposal engine 120 may vary depending on the sophistication and capabilities of the access point, the organization or individual that owns or controls the access point, and/or the technical and business arrangements that provide the connectivity (e.g., Internet connectivity) for the access point.

In some implementations or scenarios, a proposal engine 120, associated with an access point, may reside outside the access point (e.g., on another computing device in alternative network 160 or on BX platform 110). This allows access points that can only broadcast their Service Set Identifiers (SSIDs) and/or unique identifiers (e.g., a Basic SSID (BSSID), Media Access Control (MAC) address, etc.) to be used in the bandwidth exchange market to provide connectivity services to UEs 170.

Selection engines 130 of UEs 170 that can receive the beacons of an access point can obtain the terms and conditions and other information from BX platform 110, using the identifying information (e.g., SSID, a BSSID, MAC address, or other unique identifier) of the access point as a reference. This may be facilitated by including, in the SSID of the access point, an indication or information about its participation in alternative network 160 (e.g., by including a specific character string in the SSID). Thus, selection engine 130 may check for the terms and conditions for a given access point without having to go through lists of participating access points' identifiers. In an embodiment, BX platform 110 may periodically download unique identifiers (e.g., BSSIDs MAC addresses, etc.), SSIDs, locations, associated terms and conditions, and/or any other information about participating access points to alternative network 160 that are located in the vicinity of the current location of UE 170. This expedites access to the relevant terms and conditions, and makes it possible to have this information available at UE 170, even in situations where UE 170 does not have an open data connection to the Internet or BX platform 110 (e.g., UE 170 is not able to see a cellular access point or is a Wi-Fi™ only device). The current location of the UE 170 can be obtained from a GPS system, if available, or by having the access point transmit identifiers of access points in its range (e.g., regardless of whether or not the access points are registered with BX platform 110) and having BX platform 110 correlate these access point identifiers to a database of access point locations. If the location of a UE 170 is constantly changing (e.g., because UE 170 is moving in a vehicle), BX platform 110 can extend the range of access points, to include in the list of access points transmitted to UE 170, in the direction of the UE's movement. The downloads may be scheduled to happen at regular intervals or they may be scheduled to take place every time a UE 170 has network access (possibly establishing a minimum interval between downloads). This enables UEs 170 that only have one radio system (e.g., Wi-Fi™ radio system) to utilize the bandwidth exchange.

In an embodiment, a UE 170 may trigger or request information about available access points (e.g., access points not already configured for use by UE 170) from BX platform 110. For example, UE 170 may provide its current location to BX platform 110. In response, BX platform 110 may compile one or more access points (e.g., a list of access points within the vicinity of the UE's current location and/or available for use by UE 170) that have been registered to provide connectivity services in alternative network 160. BX platform 110 may provide this list (e.g., via a download over home network 150 or alternative network 160) to UE 170. The list may include, for each access point, one or more of the following:
(1) Party that is offering the connectivity service.
(2) Offered price that can be used in all circumstances, for at least a minimum time period (e.g., few minutes), until UE 170 can connect to BX platform 110 to get an updated price. This allows UE 170 to connect to alternative network 160, even when UE 170 is a Wi-Fi™ only device or when conditions make it impractical to get a current price over home network 150 (e.g., due to congestion or UE 170 being out of coverage of home network 150). The offered price may be specific to UE 170, a type of UE 170, the end user of UE 170, a class of end users, a time of day, a day of week or month, etc. BX platform 110 can be aware of the attributes of UE 170, and may tailor the offered price in accordance with those attributes.
(3) Sponsor(s). A sponsor is a party that pays for the connectivity services. For example, a cellular or Internet service provider may pay for services made available to its subscribers, a business (e.g., coffee shop, online gaming provider, etc.) may pay for services made available to its patrons, etc.

The list of access points, provided by BX platform 110, may include information for a number of access points within a certain radius (e.g., ten miles) of the current location of UE 170 or a location specified by the end user of UE 170 (e.g., via a user interface). Selection engine 130D of UE 170 may scan for available access points and compare the connectivity options provided by the visible access points based on rules and policies 132. This comparison may include measuring the performance characteristics (e.g., signal strengths, data speed) of one or more visible access points. Selection engine 130D combines the information from BX platform 110 with the measured performance characteristics to make a selection of a connection. For example, rules and policies 132 may provide that: (1) if the performance characteristic (e.g., signal strength) is above a threshold (e.g., set to indicate adequate performance) for two or more visible access points, select the access point offering the lowest price; and (2) if the performance characteristic (e.g., signal strength) is below the threshold for all of the visible access points, select the access point having the highest signal strength. Once a connection has been established, it may be reevaluated, according to rules and policies 132, if the performance characteristic falls below a set threshold or at regular intervals. In the case that intervals are used, the intervals may be static or may depend on the price of the current connection or any other parameter known to UE 170.

When a UE 170 establishes a new connection, one or more communications on the previously existing connection may be transferred to the new connection, prior to termination of the previously existing connection. In other words, UE 170 may associate communication with the access point supporting the new connection and disassociate the communication with the access point supporting the previously existing connection. In addition, UE 170 may send a usage report for the previously existing connection (e.g., once it has been terminated, assuming it is registered with BX platform 110) to BX platform 110 over the new connection. BX platform 110 may store this usage report for billing, payment, analysis, and/or other purposes.

In an embodiment, an access point of alternative network 160 may execute a proposal engine 120C that stores the terms and conditions 122 for using the services provided by the access point, along with other information, and provide these terms and conditions 122 and/or other information directly over the wireless link to a selection engine 130D of each UE 170 that requests to receive them. This can be done using the 802.11u standard, if both devices are capable of using this protocol. A multi-round, two-way negotiation (or an auction) about terms and conditions 122 may be automatically carried out between UE 170 and the access point of alternative network 160. In this case, the access point may offer a price, UE 170 may counter with a lower price, the policies in the access point may enable it to offer another price based on the counter offer, and so on and so forth. In some environments, a subset of access points may have internal proposal engines 120C, while another subset of access points rely on proposal engines within alternative network 160 or on BX platform 110 (i.e., proposal engine 120A).

Terms and conditions 122 may have short periods of validity, and connectivity may be re-negotiated at specific intervals, as situations in terms of need and available capacity will constantly vary. In the event that an access point is managed by proposal engine 120A on BX platform 110, terms and conditions 122 for that access point, including the validity periods for terms and conditions 122, may be automatically downloaded to UEs 170. In the event that the access point is managed by proposal engine 120A and UE 170 is managed by selection engine 130A on BX platform 110, terms and conditions 122, including their validity periods, may be made available to both proposal engine 120A and selection engine 130A. In some implementations, BX platform 110 can instruct a UE 170 to immediately terminate a connection with an access point and/or temporarily or permanently block UE 170 from attempting to connect to that access point.

1.1.2 Selection Engine

A UE 170 that participates in the BX market may have the ability to establish multiple wireless connections and/or change one or more wireless connections. For simplicity a system that utilizes both Wi-Fi™ and cellular wireless connections is described, but different implementations can use any combination of these and other available wireless technologies. Selection engine 130 (e.g., selection engine 130A and/or selection engine 130D) manages this connectivity for UEs 170 through a connection between each UE 170 and BX platform 110. Selection engine 130 bases its operation on rules and policies 132 (e.g., rules and policies 132A and/or rules and policies 132D) that have been set by the wireless operator and/or the end-user of UE 170. In some implementations, there is a selection engine 130 on both UE 170 and BX platform 110. These two selection engines 130A and 130D operate in tandem using the rules and policies 132A and 132D, respectively. In some cases, rules and policies 132A are controlled by the operator, and rules and policies 132D are controlled by the user. There can be a set of default rules and policies 132, so that the user does not need to do anything to begin participating in the BX market.

In an embodiment, selection engine 130D and rules and policies 132D, together with information about access points to alternative network 160 within the sector or other vicinity of UE 170, may be downloaded to UE 170, and subsequently used to make an initial decision of whether or not to establish a connection to alternative network 160, even when no other network connection is available. This initial decision may be based on a set of rules and policies 132D that is simpler and less dynamic, for example, than rules and policies 132A. Once a connection to BX platform 110 and selection engine 130A can be established, selection engine 130A can use rules and policies 132A (e.g., together with additional information, such as price, performance characteristics, etc.) to revisit and possibly revise the initial selection. Rules and policies 132A may be updated more frequently than rules and policies 132D. In the event that the initial selection is revisited and revised to abandon the connection based on rules and policies 132A, there may be a minimum time period that must elapse before the connection is severed, in order to avoid the negative user experience that may result from a momentary connection.

UE 170 may comprise mobile equipment (ME), a user identity module, and a BX application (e.g., a client application executed by a processor of UE 170) stored in the memory of the device (e.g., along with other applications). Each UE 170 that participates in the bandwidth exchange may have the ability to establish multiple wireless connections, for example, via multiple technologies (e.g., 2G, 3G, 4G/LTE, 5G, Bluetooth™, mobile satellite service, and/or any other wireless radio access). Selection engine 130 manages the connectivity available to UE 170.

In an embodiment, selection engine 130 can operate independently of UE 170 on any system (e.g., platform 110) that communicates with a standard authentication server. Alternatively, selection engine 130 may operate as a cooperative combination of functions executed on UE 170, platform 110, and the authentication server. When the selection engine 130 for a given UE 170 is executed on platform 110, the selection engine 130 may manage the UE's connections through a network connection (e.g., through home network 150 or alternative network 160). Selection engine 130 may base its management operation on rules and policies 132. Rules and policies 132 may be set by the home network operator, alternative network operator, and/or the end user of UE 170.

In an embodiment, a selection engine 130A is executed by a platform 110 and a selection engine 130D is executed by UE 170. In this case, selection engines 130A and 130D may operate in tandem using both rules and policies 132A, stored on platform 110, and rules and policies 132D, stored on UE 170. Rules and policies 132A may be controlled by the home and/or alternative network providers, whereas rules and policies 132D may be controlled at the discretion of the end user of UE 170. A default set of rules and policies 132D may be provided, so that the user does not need to do anything to activate the system.

Rules and policies 132 control which of the connection(s), available to a UE 170, will be selected at any given time. The level of sophistication and complexity in the selection process of selection engine 130 may vary for different implementations. For example, one or more of the following parameters may be considered during the selection process:
(1) Price and/or other terms and conditions for using the services offered by an access point of alternative network 160 (i.e., the ask price). These may be provided by proposal engine 120. The ask price may be specific to a particular access point or group of access points, and may depend on a number of factors, including the time of day, day of the week or month, dynamic network operating parameters (e.g., load), and/or any other information available to proposal engine 120. The ask price may also depend on the characteristics and parameters associated with UE 170 (e.g., the service provider of home network 150). The ask price may also depend on the buyer of the wireless services (e.g., the end user of UE 170 or service provider of home network 150). For example, if the end user of UE 170 has a subscription with a certain service provider (e.g., cable broadband service provider) and the particular access point of alternative network 160 belongs to a network of the service provider or an affiliate or partner of the service provider (e.g., a provider of hotspots), the ask price for that particular end user may be zero. The ask price for other end users, who do not have such a subscription, may be non-zero.
(2) Price and/or other terms and conditions offered by the buyer for using services of an access point of alternative network 160 (i.e., the bid price). The bid price may depend on a number of factors, including the time of day, day of the week or month, dynamic network operating parameters (e.g., load) of home network 150, information about UE 170, the end user's contract with a service provider of home network 150, the end user's association with other organization(s), and/or any other information available to selection engine 130.
(3) Quality of the signal from the access point providing the connection, based on a measurement of signal strength (e.g., received signal strength indication (RSSI), signal-to-noise ratio (SNR), signal-to-interference-plus-noise ratio (SINR)) or any other relevant parameter that may be detected by each radio system of UE 170 for which a connection is available.
(4) Level of security available for using the connection.
(5) Traffic load on the network providing the connection (e.g., physical resource block usage, peak or busy-hour traffic, etc.).
(6) Throughput capacity of the connection.
(7) Reliability (e.g., packet loss) of the connection.
(8) Latency and jitter of the connection.
(9) Bandwidth, or any other specific characteristic of connectivity, needed by each application executing or to be executed on UE 170.
(10) Specific application, executing on UE 170, that is requesting or using the services provided by the access point of alternative network 160.
(11) Specific service (e.g., website being accessed) to which UE 170 (e.g., an application executing on UE 170) is requesting access.
(12) Sponsorship for or promotions related to the connection (e.g., websites or specific promotions available or required through the connection);
(13) Buyer(s) for the service. For a specific service, the service provider of home network 150 may be requesting access to the service, but the buyer may be a sponsor of the service, such as a company that provides access to data services when a specific application is being executed in the foreground or is the main active application on UE 170. The buyer could also be the service provider of home network or the end user of UE 170. Each potential buyer of a particular service may have a different bid price.
(14) Acceptability, to an application or the end user, of a delay in transmitting data from UE 170 to the network or transmitting data from the network to UE 170. For example, an application provider or end user may specify an acceptable delay for a data transmission in terms of a time that may elapse between the request to transmit the data and the actual transmission of the data. Thus, an end user could specify that a delay of one hour is acceptable for uploading photographs to a website (e.g., social media site). In this case, selection engine 130 may wait up to one hour to see if a free or cheap connection (i.e., zero price or price below a certain threshold) becomes available for the upload. If the one hour elapses without such a connection becoming available, selection engine 130 may then select a connection with a higher cost (i.e., non-zero price or price above the certain threshold). Different acceptable delays may be set for different cost levels or other characteristics of the connection (e.g., terms and conditions other than price).
(15) Estimated drain on battery power in UE 170 resulting from use of the connection.
(16) Speed, reliability, or other performance characteristics of any alternative connection available to UE 170 (e.g., a connection that UE 170 is currently using or has used in the past). For example, if the data transfer speed of a connection, provided to UE 170 by the mobile network operator with whom the end user has an agreement, falls below a set threshold, the selection decision may be affected. As another example, if UE 170 is connected to an access point of alternative network 160, but the data transfer speed, packet loss, or other performance characteristic falls below a set threshold, a prior selection decision could be revisited using this information about the existing connection.
(17) Result of a speed test or other performance test of a connection. UE 170 may conduct a speed test or other performance test of its connection to an access point at any time (e.g., immediately after initially establishing the connection). The performance test may be based on observing the data access speed of another application that is communicating over the connection, or it may comprise a speed test that is specifically initiated by UE 170 to check the quality of a new connection immediately after establishing the connection. If the result of the test indicates that the tested performance characteristic (e.g., speed) is below a set threshold (which may depend on UE 170 and/or applications using the connection), selection engine 130 may reverse the decision to select the particular access point and/or network for the connection and select a new access point and/or network. In an implementation, the performance test utilizes criteria that include the data transmission speed observed immediately before connecting to a new access point. For example, the decision to connect may be reversed if the data transmission speed is not higher than the speed observed before connecting to the new access point.
(18) Geographic location of UE 170.
(19) Radio (e.g., cellular base station) to which UE 170 is connected.
(20) Information about the movement of UE 170, as determined, for example, from motion sensors or accelerometers on UE 170 or from tracking Global Positioning System (GPS) data collected by UE 170.
(21) Special instructions, for example, from the network operator(s), UE 170 end users, and/or access point operator(s).

In some instances, some of the connection alternatives may have lower cost or be free. For example, one or more access points of alternative network 160 may be sponsored by a business that provides free wireless access in exchange for acceptance of commercial messages and advertising. Free access to certain websites or services may be provided by certain companies (e.g., gaming companies) or by certain applications (e.g., gaming applications). Service providers or vendors may sponsor connectivity that allows the end user to visit the provider's or vendor's website to make purchases. Other access points may offer lower cost or free connectivity, but require the right to collect location-based information of the end user or may require responses from the end user to survey(s). One example of collecting useful location-based information would be to collect the GPS location of UEs 170 at specific intervals (e.g., to measure the speed of traffic flows on roads and freeways). This could be a commitment by the end user of UE 170 that would be valid, even when UE 170 is connected through home network 150, and which could earn privileges to use alternative network 160 as a form of compensation.

Selection engine 160 may select which data connection to use for each of the applications executing on UE 170. In one embodiment, these selections are performed on a real-time, moment-to-moment basis, using the rules and policies 132 and current information about each available connection (e.g., price and/or other parameters listed above). This information may be available directly from the access point, for example, by using the 802.11u communication standard, or it may be obtained from BX platform 110 based on a reference system.

In an embodiment, selection engine 130 uses rules and polices 132, set by the operator of BX platform 110 and/or the end user of UE 170, that authorizes the use of connections based on a combination of two main parameters: the speed or other performance characteristic of the connection that is currently available to UE 170 from home network 150; and the cost of an alternative connection available to UE 170 through alternative network 160. Rules and policies 132 may have thresholds for the performance characteristic and the cost. The thresholds may be tiered. For example, selection engine 130 may offload a UE 170 from home network 150 to alternative network 160 under either of the following tiered conditions: a) offload a UE 170 from home network 150 to alternative network 160 to increase its data speed that is below 5 Mbps for up to fifty cents per time period; b) offload a UE 170 from home network 150 to alternative network 160 to increase its data speed that is below 1 Mbps for a price of up to two dollars per time period; and so on and so forth.

In an embodiment in which selection engine 130 is at least primarily hosted on BX platform 110, UE 170 will send the set of selection parameters to selection engine 130A on BX platform 110, and selection engine 130A will return to UE 170, the identifying information and necessary authentication information for connecting to a connectivity provider that will provide the selected connection.

In an alternative embodiment in which selection engine 130 is at least primarily hosted on UE 170, selection engine 130D on UE 170 will use the available selection parameters (e.g., from proposal engine 120) to make the selection of an access point through which it will establish a connection. UE 170 may then communicate this information to BX platform 110 and responsively receive the authentication information that will enable the connection. The authentication information can be transmitted and/or exchanged using a protocol (e.g., 802.1x, Extensible Authentication Protocol (EAP), etc.) that is the same or different from the protocol used in communication.

In an embodiment, selection engine 130 compares the ask price and bid price, which may both depend on a number of parameters as described above. If the ask price (e.g., plus a possible commission or other compensation for the operator of BX platform 110) is lower than the bid price, selection engine 130 establishes a clearing price for the connectivity service. This price may be a price per byte transmitted, price per time of connectivity, or any other unit of pricing. The clearing price is then applied by accounting engine 140 to establish the necessary payments and settlements between the buyer and the seller of the connectivity service.

Once a connection is selected, selection engine 130 may provide, to UE 170, any information that is necessary to establish the connection through the selected access point. This information may include authentication and authorization information. The authentication and authorization information may include wireless passphrases or passwords, account identification information and passwords, credentials for an access control gateway, detailed information about how to post a user name and password to a captive portal, digital certificates, and/or other access control tokens and parameters. Selection engine 130 controls these authentication and authorization elements, which may be stored in encrypted form in a database of selection engine 130A and/or 130D. If the authentication and authorization elements are stored in selection engine 130D on UE 170, the elements may be downloaded together with other information about the access points in the vicinity of UE 170. These authentication and authorization elements may have expiration times and may be refreshed at regular intervals. The authentication and authorization elements are made available to the UE's connection functions only at the time of connection and are subsequently erased from the UE's memory. The end user will not have any access or visibility to the authentication or authorization information, used by selection engine 130, except in implementations or scenarios in which the end user must manually provide such information to connection functions of UE 170.

In an embodiment, based on the connection selections and measured data traffic through each connection, UE 170 generates a detailed record on the actual use of each connection to alternative network 160, utilizing accounting engine 140. At intervals, accounting engine 140 transmits the usage record to BX platform 110, including identifying information of UE 170 and/or the end user and identifying information of each of the access points that provided each used connection. The usage record may also identify the selected buyer of each connection, include the negotiated price for each connection, indicate the terms and conditions in force at the time the connection was used, and/or include connection parameters. The reporting of connection parameters can be performed in any manner. For example, the reporting can be performed using the Remote Authentication Dial-In User Service (RADIUS) or Diameter protocol standard for mobile devices, Wireless Roaming Intermediary Exchange (WRIX), or another standard for access, authorization, and accounting to keep track of usage by UEs 170.

The usage record may also include usage data in the form of numbers of sent and received data bytes, time duration of the connection, and/or any other measure of usage. The usage data may also include information about the application(s) that were using the connection, websites or other resources that were accessed by the application(s) during use, and/or parameters of the connectivity service, such as the connection speed, jitter, latency, and/or other performance characteristics. The usage data for alternative network 160 may be collected by UE 170 (e.g., using accounting engine 140D), and communicated to BX platform 110 to be used for payment and billing (e.g., to sponsors of wireless connectivity).

In an embodiment, the operating system (e.g., Android™, iOS™, Microsoft Windows™, etc.) in UE 170 enables use of connections to alternative network 160 by any application and regardless of the websites or resources that are accessed. In this case, UE 170 may execute a specific browser that is controlled by or interfaced with accounting engine 140 to control and limit the resources that can be accessed. The browser may also include or be interfaced with a module that keeps track of the resources accessed (e.g., websites visited) and stores the number of bytes (or other measure) used for each resource accessed. This information can then later be used by accounting engine 140 to allocate usage per resource. In this manner, third parties (e.g., gaming providers), web stores, or content providers can sponsor or provide end users with free or reduced-cost access to their products and services on the web. The tracking may cover any and all available access points and networks, and the stored usage data can be used by BX platform 110 to accumulate the costs to the sponsors according to the sponsorship arrangements.

BX platform 110 may collect other statistics from UEs 170, such as the location of each UE 170, and the signal quality, throughput, speed, or availability of access points to home network 150 (e.g., cell tower identifiers) and/or alternative network 160 at each location and/or at specific times. BX platform 110 may use these statistics to compile useful information about the quality of connections in various locations and/or at specific times, and infer the need for data capacity or report time-of-use data and historical trends. Such reports could be sold to wireless network operators, or made available (possibly for a fee or in the form of a marketing campaign) to owners of access points of alternative network 160, potential future owners of access points of alternative network 160, or residents or owners of buildings and other structures in the vicinity of each location for which usage data has been collected. The information from the reports could be used by the operators and owners to make decisions about pricing or adding capacity in the form of registering existing access points with BX platform 110, installing new access points, and/or adding new alternative networks. These actions would provide an opportunity to the owners of buildings or access points to participate in the bandwidth exchange market.

In an embodiment, selection engine 130 may use several different radio connections simultaneously. The connections may be selected individually for different applications running on UE 170 or may be aggregated to provide a higher total data transmission capability for a single application. In other words, UE 170 can “pool” resources to increase the overall data transmission speed.

Selection engine 130 may use a combination of information to implement the rules and policies 132 for selecting connectivity. For example, selection engine 130 may be aware of the connections provided directly by the wireless operator using home network 150 and may be familiar with the connectivity through access points that have been configured for a given UE 170 by the end user (e.g., access points at the user's home, office, and/or other locations where free connectivity is available to the end user). However, in BX platform 110, real-time information about connectivity is available from proposal engines 120C, residing in third-party access points of alternative network 160, or elsewhere in alternative network 160 at a location from which it can be accessed by selection engine 130. In order to participate in providing connectivity through alternative network 160, each access point must have a proposal engine 120 or provide a reference to a proposal engine 120.

1.1.3 Accounting Engine

Regardless of the level of sophistication supported by proposal engines 120 and selection engines 130, over time, each UE 170 will use connections through different access points. In order to keep track of the actual usage of each connection, and to provide information for compensation and settlements within the bandwidth exchange market, each UE 170 is covered by a local accounting engine (e.g., accounting engine 140D) or server-based (e.g., cloud-based) accounting engine 140 (e.g., accounting engine 140A).

In an embodiment, accounting engine 140 keeps track of the usage of connections by UE 170 and reports it to platform 110. Specifically, accounting engine 140 keeps track of the usage of alternative network connections by each UE 170, as well as the specific terms and conditions 122 established between the proposal engine 120 and selection engine 130 for each specific usage of alternative network connections by the UE 170. Accounting engine 140 collects and provides this data to platform 110, which utilizes the data to implement the micro-commerce and reward and incentivize all participants in the bandwidth exchange market.

As a minimum condition for participating in the bandwidth exchange market, each UE 170 may be required to execute an accounting engine 140 (e.g., accounting engine 140D) or be covered by at least one accounting engine 140 (e.g., accounting engine 140A) associated with the alternative network. In a split implementation, accounting engine 140 may comprise one module executing on UE 170 and another module executing on a server of the alternative network access provider. In this case, platform 110 may receive usage reports from the module on UE 170 and/or the module on the server of the alternative network access provider. In at least some instances, platform 110 will receive usage reports from both modules, which provides an opportunity to audit the usage reports from both UE 170 and the alternative network access provider to ensure that the usage is being accurately reported.

To the extent the capability is available, access points may include an accounting engine 140C that can collect information about the usage of data capacity by each UE 170. If such records are collected and made available to BX platform 110, they may be recompiled and used to verify the usage records provided by the accounting engines 140D in UEs 170. In an embodiment, BX platform 110 automatically logs into the administrator's interface of registered access points (e.g., using credentials provided by the access point owners during initial registration with BX platform 110), in order to retrieve usage reports that indicate the usage of connectivity by each participating UE 170. This capability may be utilized in at least a subset of access points to provide a useful auditing function and ensure that the reporting by the accounting engines of UEs 170 (e.g., accounting engines 140A and/or 140D) is accurate.

1.1.4 Bandwidth Exchange Platform

In an embodiment, BX platform 110 manages all the information for implementing the micro-commerce between home network providers, alternative network access providers, owners of access points, and the end users of wireless devices. Management of the exchange may include: managing messaging and/or instructions for transferring or swapping UEs 170 between home network 150 and alternative network 160; managing terms and conditions 122; managing usage records 142; and providing billing and payment services to all parties. As discussed elsewhere herein, BX platform 110 may be implemented as software modules executing on one or more dedicated servers or in the cloud.

1.2. Example Processing Device

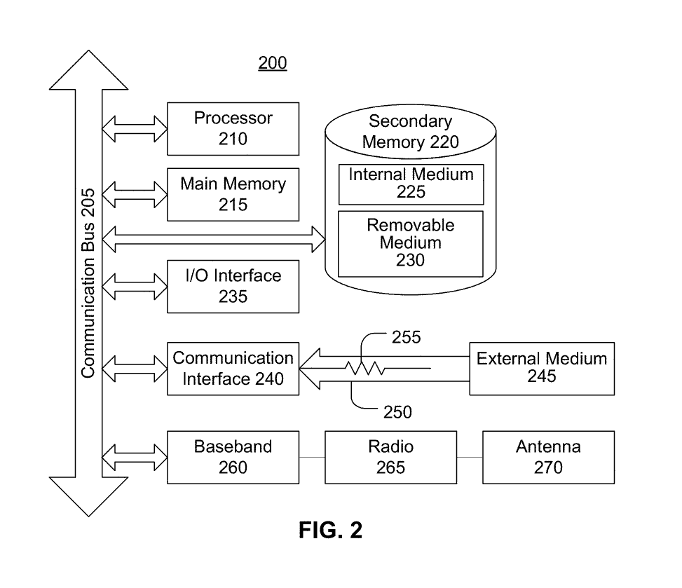

FIG. 2 illustrates an example wired or wireless system 200 that may be used in connection with various embodiments described herein. For example system 200 may be used as or in conjunction with one or more of the mechanisms, processes, methods, or functions (e.g., to store and/or execute one or more software modules of the application) described herein, and may represent components of platform 110, access points of home network 150 and/or alternative network 160, UEs 170, and/or other processing devices described herein. System 200 can be a wireless device, a server, a conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPM), IEEE 696/S-100, and the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random-access memory (DRAM) and/or static random-access memory (SRAM). Other semiconductor-based memory types include, for example, synchronous dynamic random-access memory (SDRAM), Rambus dynamic random-access memory (RDRAM), ferroelectric random-access memory (FRAM), and the like, including read-only memory (ROM).

Secondary memory 220 may optionally include an internal memory 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, etc.

Removable storage medium 230 is a non-transitory computer-readable medium having stored thereon computer-executable code (e.g., disclosed software modules) and/or data. The computer software or data stored on removable storage medium 230 is read into system 200 for execution by processor 210.

In alternative embodiments, secondary memory 220 may include other similar means for allowing computer programs or other data or instructions to be loaded into system 200. Such means may include, for example, an external storage medium 245 and a communication interface 240, which allows software and data to be transferred from external storage medium 245 to system 200. Examples of external storage medium 245 may include an external hard disk drive, an external optical drive, an external magneto-optical drive, etc. Other examples of secondary memory 220 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 200 with a network or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network, or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs, such as the disclosed application, or software modules) is stored in main memory 215 and/or the secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code (e.g., software and computer programs) to system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable mediums are means for providing executable code, programming instructions, and software to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform the features and functions described elsewhere herein.

In an embodiment, I/O interface 235 provides an interface between one or more components of system 200 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and the like.

System 200 may also include optional wireless communication components that facilitate wireless communication over a voice network and/or a data network. The wireless communication components comprise an antenna system 270, a radio system 265, and a baseband system 260. In system 200, radio frequency (RF) signals are transmitted and received over the air by antenna system 270 under the management of radio system 265.

In one embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also codes the digital signals for transmission and generates a baseband transmit audio signal that is routed to the modulator portion of radio system 265. The modulator mixes the baseband transmit audio signal with an RF carrier signal generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments. For example, data storage areas 215 or 220 may include various software modules.

2. Process Overview

Embodiments of processes for alternative network access will now be described in detail. It should be understood that the described processes may be embodied in one or more software modules that are executed by one or more hardware processors (e.g., server application, client application, and/or a distributed application comprising a combination of server and client applications), which may be executed wholly by processor(s) of platform 110, wholly by processors of an access point or a server or gateway within home network 150 and/or alternative network 160, wholly by processor(s) of UEs 170, or may be distributed across any combination of two or more of these devices. The described process may be implemented as instructions represented in source code, object code, and/or machine code. These instructions may be executed directly by the hardware processor(s), or alternatively, may be executed by a virtual machine operating between the object code and the hardware processors.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

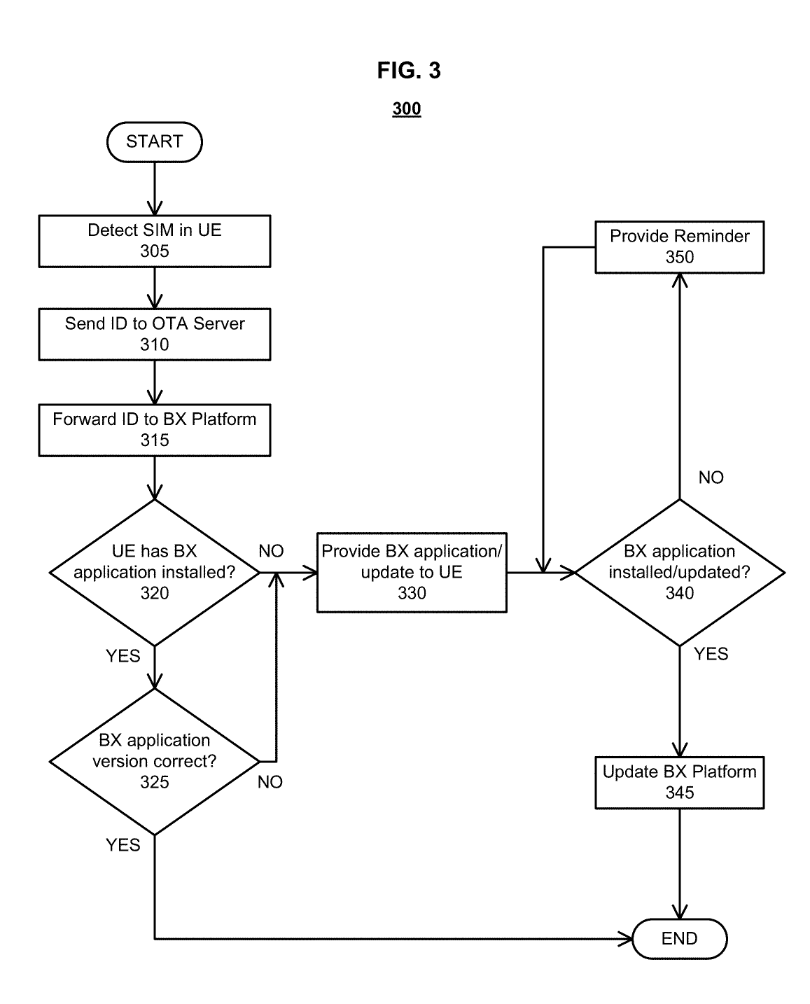

FIG. 3 illustrates an example process 300 for application management in a mobile device, according to an embodiment. While process 300 is illustrated with a certain arrangement of steps, process 300 may be implemented with fewer, more, or different steps and a different arrangement or ordering of steps. Furthermore, while process 300 will be described under the assumption that there is only one software application to be installed or updated, process 300 may be applied to any number of software applications (e.g., by executing process 300 or portions of process 300 for each software application), including a batch of a plurality of software applications.

In step 305, process 300 detects a SIM 172 in UE 170. Step 305 may be performed by the operating system of a given UE 170 or an application executed by the given UE 170. In an embodiment, step 305 may be triggered by the introduction of a new SIM 172 into the UE 170. The introduction of a new SIM 172 may comprise the insertion of a physical SIM card into a receptacle of UE 170, the download of a new eSIM profile in an eSIM-enabled UE 170, or booting up the UE 170 with the physical SIM card inserted or eSIM profile downloaded. In a BYOD scenario, this may occur when the user receives a SIM 172 for his or her mobile device from an MNO or a service provider.

In step 310, an identifier of UE 170 and/or an identifier of a subscription associated with UE 170 are transmitted to OTA server 156. Step 310 may be performed by an application or applet residing in SIM 172. The transmission process may comprise several remote file management (RFM) updates and/or remote applet management updates. The identifier(s) transmitted to OTA server 156 may include, without limitation, an International Mobile Equipment Identity (IMEI) and a Mobile Station International Subscriber Directory Number (MSISDN). The IMEI and/or MSISDN may be transmitted over a data communication network (e.g., using IP-based data communication, such as HTTPS). Alternatively, the IMEI and/or MSISDN may be transmitted via a signaling network. In either case, OTA server 156 is updated with the new IMEI and/or MSISDN for the UE 170.

In step 315, the identifier(s) (e.g., IMEI and MSISDN), transmitted to OTA server 156 in step 310, are forwarded by OTA server 156 to BX platform 110 (or another module of BX platform 110 in embodiments in which OTA server 156 is comprised in BX platform 110). The identifier(s) may be forwarded to the appropriate resource of BX platform 110 using commands of the API provided by BX platform 110. In an embodiment, in which OTA server 156 is separate from BX platform 110, the identifier(s) may be sent over an IP-based Virtual Private Network (VPN) connection.

In step 320, BX platform 110 determines whether or not the UE 170 has previously installed the BX software application (e.g., by downloading the application, accepting terms and conditions for using the application, and/or granting permissions to the application). This determination may comprise performing a lookup in a database of BX platform 110 using at least one of the identifier(s) of UE 170 (e.g., IMEI), sent by UE 170 in step 310 and relayed by OTA server 156 to BX platform 110 in step 315. If a record exists in the database for the identifier(s) and indicates that the UE 170, associated with those identifier(s) (e.g., IMEI and/or MSISDN), has installed the BX software application, BX platform 110 may determine that the UE 170 has previously installed the BX software application. Alternatively, the record may indicate whether and/or how frequently the UE 170 has been using the BX software application, and BX platform 110 may determine that the UE 170 has previously installed the BX software application only if the record indicates that the UE 170 has used the BX software application and/or has been actively or frequently using the BX software application. Otherwise, if no record exists in the database for the identifier(s) or a record exists but does not indicate that the UE 170, associated with those identifier(s), has installed or used the BX software application (e.g., the BX software application has not been used for a certain past time period, such as several weeks), BX platform 110 will not determine that the UE 170 has previously installed the BX software application. If BX platform 110 determines that the UE 170 has previously installed the BX software application (“YES” in step 320), process 300 proceeds to step 325. Otherwise, if BX platform 110 does not determine that the UE 170 has previously installed the BX software application (“NO” in step 320), process 300 proceeds to step 330. BX platform 110 may also attempt to retrieve other contextual information, such as whether or not the received identifier(s) represent a new subscription or an existing account that is requesting a subscription for a new UE 170.

In step 325, BX platform 110 determines whether or not the UE 170, which has been determined in step 320 to have already installed the BX application, has installed the correct version (e.g., most current version) of the BX application. This determination may comprise comparing a correct version number (e.g., most current version number) of the BX application to a version number associated with the identifier(s) of the UE 170 (e.g., in the record retrieved from the database in step 320). If the BX application installed by the UE 170 is determined to be the correct version (i.e., “YES” in step 325), process 300 ends. Otherwise, if the BX application installed by the UE 170 is not determined to be the correct version (i.e., “NO” in step 325), process 300 proceeds to step 330 to update the BX application to the correct version.

In step 330, BX platform 110 provides the BX application or an update to the BX application to UE 170. It should be understood that, if process 300 enters step 330 from step 320, an installation would be necessary, whereas, if process 300 enters step 330 from step 325, an update would be necessary. Step 330 may be implemented by a variety of mechanisms, including via a SIM-based applet or an SMS message.

In the event that step 330 is implemented using a SIM-based applet mechanism, OTA server 156 (e.g., upon receiving an instruction from BX platform 110) transmits and installs the SIM-based applet (or other type of application) on SIM 172 of UE 170. The applet may be transmitted from OTA server 156 to SIM 172 via a binary SMS message over a data communication network or a signaling network. In an embodiment, the applet on SIM 172, once installed, may be executed to display a user interface (e.g., using an embedded Uniform Resource Locator (URL)) on a display of UE 170. The user interface is designed (e.g., with multimedia and/or inputs) to prompt a user to install or update the BX application on the user's UE 170. The user can either choose to install or update the BX application via inputs of the user interface, or close, bypass, or ignore the user interface.

In the event that step 330 is implemented using an SMS-based mechanism, BX platform 110 may directly or indirectly send an SMS message to the UE 170 using the identifier of a subscription associated with the UE 170 (e.g., MSISDN) for routing. For example, BX platform 110 may initiate transmission of an SMS message to UE 170 via a remote SMSC server. Specifically, BX platform 110 may instruct the SMSC server to send the SMS message to UE 170. Alternatively, BX platform 110 may comprise a SMSC server, in which case BX platform 110 may send the SMS message directly to UE 170 via its local SMSC server. In either case, the SMS message may comprise a URL that references information for downloading an installation or update file for the BX application. The URL may be a reference to a landing page of a distribution platform (e.g., Apple™ App Store, Google Play™, or other third-party platform) that provides an input for downloading or updating the BX application. Alternatively, the URL may be a reference to a private server. To improve the user experience, the SMS message may be a multimedia message with the URL embedded within. In any case, once the SMS message is received at the UE 170, the user can open the SMS message, select the URL link, and proceed to install or update the BX application. Alternatively, the user may choose to ignore or even delete the SMS message without installing or updating the BX application.

In step 340, it is determined whether or not the user has completed the installation or update provided in step 330. This determination may be performed by an application executing on UE 170 (e.g., the SIM-based applet installed in step 330) or by BX platform 110 (e.g., in the event that the SMS-based mechanism was used in step 330), and may be determined when UE 170 starts using the BX application. If the user has completed the installation or update (i.e., “YES” in step 340), process 300 proceeds to step 345. Otherwise, if the user has not completed the installation or update (i.e., “NO” in step 340), process 300 proceeds to step 350.

In step 345, once it has been determined that the installation or update has been completed, BX platform updates the database (e.g., the record retrieved in step 320) to reflect that the UE 170 has installed the BX application and/or the version of the BX application installed on the UE 170, as well as any other contextual information. The indication that the installation or update has been completed may be provided in a message sent from the UE 170 to BX platform 110 (e.g., via home network 150 or alternative network 160). This message may be triggered when UE 170 starts using the BX application (e.g., upon initialization or execution of the BX application, after the BX application has been used for a certain time period, such as several weeks, after the BX application has been used a certain number of times or with a certain frequency, etc.). After the database at BX platform 110 has been updated, process 300 ends.

In step 350, a reminder is provided to the user of the UE 170. In the event that the SIM-based applet was installed on SIM 172 in step 330, the applet may provide the reminder (e.g., by launching a user interface on the display of UE 170). Otherwise, if BX platform 110 is used to provide the reminders, BX platform may send an SMS message (e.g., when BX platform 110 comprises a SMSC server) or initiate the transmission of an SMS message from a remote SMSC server to UE 170, to remind the user to install or update the BX application on his or her UE 170. The reminder SMS message may be similar or identical to the SMS message described above with respect to the SMS-based mechanism in step 330 (e.g., including a URL for downloading the installation or update file).

Whether by the applet, SMS message, or other mechanism, the reminders may be provided periodically at an appropriate interval or frequency, until it is determined in step 340 that the installation or update has been completed. In an embodiment, the reminders may be terminated after an appropriate time or number of intervals. The frequency and/or termination of the reminders may be determined based on market research and/or analytical data associated with user behavior. For example, the reminders may be provided once a week for a month and then terminated after the month ends, at which point process 300 ends.

In an embodiment of step 350, BX platform 110 may communicate directly with back-end systems (e.g., authentication and authorization server, policy and charging rules function (PCRF) server, etc.) of MNOs or other service providers to facilitate various enforcement actions or incentives. These actions and incentives can be used to encourage users of UEs 170 to install and/or update the BX application on their UEs 170. For example, as an action, the service provider may, in the event that a user fails to complete the installation of the BX application within a certain time period, throttle the speed of data connections for the user's UE 170 or even interrupt the user's service until the BX application has been installed. Naturally, the user should be adequately informed of any actions prior to their implementation and the applicability of such actions prior to subscribing. As an incentive, the users may be offered a few extra days of service and/or a discounted rate for a time period in exchange for installing the BX application.

In an embodiment, the SMS messages (e.g., sent in steps 330 and/or 350, and/or other messages) may be tailored to a particular user or UE 170 based on other parameters. These parameters may be stored and retrieved from a database of BX platform 110 in association with the identifier of a UE 170 (e.g., IMEI) and/or the identifier of a subscription associated with the UE 170 (e.g., MSISDN) received in step 315. In this case, an operator with multiple service brands may simply use generic SIM cards for SIM 172, and BX platform 110 can select the appropriate branding for the message (e.g., the appropriate branding for the BX application to be installed or updated) based on the identifier of the UE 170, the identifier of a subscription associated with the UE 170, and/or other identifiers (e.g., ICCID, identifier of a brand or token associated with a brand, etc.) to which the message is being sent.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method comprising using at least one hardware processor of a server to:
receive at least one identifier of a mobile device over at least one network;
determine whether the mobile device has installed a software application based on the at least one identifier of the mobile device;
when the mobile device is not determined to have installed the software application, initiate a first Short Message Service (SMS) message for providing access to the software application to the mobile device;
provide access to the software application to the mobile device via the first SMS message over at least one network; and,
after providing access to the software application to the mobile device,
determine whether the mobile device has installed the software application, and,
when the mobile device is not determined to have installed the software application, initiate at least one reminder to the mobile device, wherein the at least one reminder comprises a second SMS message.

2. The method of claim 1, wherein the at least one identifier of the mobile device is received from an over-the-air (OTA) server.

3. The method of claim 1, wherein determining whether the mobile device has installed the software application comprises:
searching for a record for the mobile device in a database based on the at least one identifier of the mobile device;
determining that the mobile device has installed the software application when the record indicates that the mobile device has installed the software application; and
not determining that the mobile device has installed the software application when no record exists for the mobile device or the record does not indicate that the mobile device has installed the software application.

4. The method of claim 3, further comprising using the at least one hardware processor of the server to, after providing access to the software application to the mobile device, when the mobile device is determined to have installed the software application, add or update a record for the mobile device in the database to indicate that the mobile device has installed the software application, wherein the record is retrievable based on the at least one identifier.

5. The method of claim 4, wherein determining whether the mobile device has installed the software application comprises:
determining that the mobile device has installed the software application when a message, indicating that the software application has been installed, has been received from the mobile device; and
not determining that the mobile device has installed the software application when no message, indicating that the software application has been installed, has been received from the mobile device, since a time at which access to the software application was provided to the mobile device.

6. The method of claim 1, wherein determining whether the mobile device has installed the software application comprises:
searching for a record for the mobile device in a database based on the at least one identifier of the mobile device;
determining that the mobile device has installed the software application when the record indicates that the mobile device has used the software application; and
not determining that the mobile device has installed the software application when no record exists for the mobile device or the record does not indicate that the mobile device has used the software application.

7. The method of claim 1, wherein one or both of the first SMS message and the second SMS message comprise a Uniform Resource Locator (URL) for a user interface for downloading the software application.

8. The method of claim 1, wherein initiating the first SMS message comprises instructing an SMS center to transmit the first SMS message to the mobile device using the at least one identifier of the mobile device.

9. The method of claim 1, wherein initiating the first SMS message comprises using the at least one hardware processor of the server to generate and transmit the first SMS message to the mobile device using the at least one identifier of the mobile device.

10. The method of claim 1, wherein providing at least one reminder comprises providing a periodic reminder at each of a plurality of intervals.

11. The method of claim 1, further comprising using the at least one hardware processor of the server to send the second SMS message.

12. The method of claim 1, wherein the software application is configured to perform automated radio management for at least one radio system of the mobile device.

13. The method of claim 1, further comprising, when the mobile device is not determined to have installed the software application after expiration of a predetermined time period, interrupting a wireless service to the mobile device.

14. The method of claim 1, further comprising, when the mobile device is not determined to have installed the software application after expiration of a predetermined time period, restricting a wireless service to the mobile device.

15. The method of claim 14, wherein restricting the wireless service to the mobile device comprises reducing a speed of wireless connections between the mobile device and at least one wireless network.

16. The method of claim 1, wherein providing access to the software application comprises providing access to an update file for updating a previous version of the software application, installed on the mobile device, to a current version of the software application.

17. The method of claim 1, wherein the at least one identifier comprises a first identifier of the mobile device and a second identifier of a subscription associated with the mobile device, wherein the first SMS message and the second SMS message are initiated using the second identifier.

18. The method of claim 17, wherein the first identifier comprises an International Mobile Equipment Identity (IMEI), and wherein the second identifier comprises a Mobile Station International Subscriber Directory Number (MSISDN).

19. A system comprising:
at least one hardware processor; and
one or more software modules that, when executed by the at least one hardware processor,
receive at least one identifier of a mobile device over at least one network,
determine whether the mobile device has installed a software application based on the at least one identifier of the mobile device,
when the mobile device is not determined to have installed the software application, initiate a first Short Message Service (SMS) message for providing access to the software application to the mobile device,
provide access to the software application to the mobile device via the first SMS message over the at least one network, and,
after providing access to the software application to the mobile device,
determine whether the mobile device has installed the software application, and,
when the mobile device is not determined to have installed the software application, provide at least one reminder to the mobile device, wherein the at least one reminder comprises a second SMS message.

20. A non-transitory computer-readable medium having instructions stored therein, wherein the instructions, when executed by a processor, cause the processor to:
receive at least one identifier of a mobile device over at least one network;
determine whether the mobile device has installed a software application based on the at least one identifier of the mobile device;
when the mobile device is not determined to have installed the software application, initiate a first Short Message Service (SMS) message for providing access to the software application to the mobile device;
provide access to the software application to the mobile device via the first SMS message over at least one network; and,
after providing access to the software application to the mobile device,
determine whether the mobile device has installed the software application, and,
when the mobile device is not determined to have installed the software application, initiate at least one reminder to the mobile device, wherein the at least one reminder comprises a second SMS message.
